(19) United States
(12) Patent Application Publication
(10) Pub. No.: US 2010/0236913 A1
(43) Pub. Date: Sep. 23, 2010

(54) Battery cover connector system

(75) Inventor: Steven S. Conrad, Rogers, AR (US)

Correspondence Address: Boyd D. Cox, 75 N. East Avenue, Suite 506, P.O. Box 573, Fayetteville, AR, 72702, US

(73) Assignee: ASSEMBLED PRODUCTS CORPORATION

(21) Appl. No.: 12/661,387

(22) Filed: Mar. 16, 2010

Related U.S. Application Data
(60) Provisional application No. 61/210,377, filed on Mar. 18, 2009.

(51) Int. Cl. H01R 13/70; H01R 24/00

(52) U.S. Cl. 200/51 R; 439/627

(57) ABSTRACT

A battery cover connector system for connecting a battery to the wiring harness of an electrical device or accessory includes a cap that fits closely over the top of the battery and a pair of terminal connectors within the cap that are adapted to snap fit onto a respective battery terminal. The system can be readily connected to the battery's positive and negative poles and conversely can be readily disconnected from the battery without the use of tools. The system includes a safety feature that deters a user from improperly making a reverse connection between the battery and the electrical device.

Priority for this application is claimed from U.S. Provisional Application No. 61/210,377 entitled “Battery Cover Connector System” filed on Mar. 18, 2009

### BACKGROUND

The present invention is directed to a battery cover connector system for connecting a battery to a wiring harness associated with an electric device. The system provides means for readily connecting the battery to the wiring harness and disconnecting the battery from the wiring harness of the electrical device.

Typically, a battery has a pair of terminals that are connected to a wiring harness associated with an electrical device. The terminals comprise a positive and negative pole, each of which is generally formed by a post extending from the battery. As part of the wiring harness cooperating wiring leads are adapted to contact and securely engage the terminal posts of the battery to electrically connect the battery and the wiring harness.

In prior art devices, the wiring harness is generally connected to the battery by a nut and bolt construction, whereby each of the harness leads are bolted onto a respective battery terminal. This arrangement typically requires the use of tools to connect and disconnect the wiring harness and the battery terminals. Consequently, the removal and installation of a battery can be time consuming and cumbersome.

Since it can be necessary to frequently connect and disconnect a battery to and from an electrical device, it is desirable that such exercise be as efficient as possible. By providing a connector system whereby a battery can be readily connected and disconnected to a wiring harness from an electrical device without the use of tools, the replacement of batteries can be greatly facilitated.

In addition, the battery cover connector system of the present invention can be used for recharging a battery. By connecting the battery to a wiring harness that is associated with a battery charger, the battery can be easily and quickly charged, as necessary.

### SUMMARY

The present invention is directed to a system that satisfies the need for quick connection and disconnection of a battery to an electrical device. The electrical device may be an electric vehicle, vehicle accessory, or other electrically-powered mechanism.

In another instance, the battery cover connector system can be secured to a wiring harness adapted to transfer a charge to a connected battery. By attaching such a battery cover connector system to the battery, the battery can be recharged. This can be done without removing the battery from a vehicle, thereby improving the convenience and ease of recharging batteries.

It is an object of the present invention to provide a device that allows quick installation and connection of a battery within a vehicle.

It is a further object of the present invention to provide a device that allows quick disconnection and removal of a battery from a vehicle.

It is a further object of the present invention to provide a battery connector that can simultaneously connect the electrical wiring harness of a vehicle to the positive and negative poles of a battery.

It is a further object of the present invention to provide a system for installing a battery in a vehicle whereby a reverse connection to the battery is deterred.

It is a further object of the present invention to provide a connecting device for a battery that properly aligns the positive and negative poles of the battery with the cooperating leads from a wiring harness in order to facilitate proper installation.

It is a further object of the present invention to provide a battery connector system having a cap that covers a top side of the battery when installed.

It is a further object of the present invention to provide a system that allows an easy connection and disconnection of a battery from a battery-powered vehicle without the use of tools.

It is a further object of the present invention to provide a system that can easily connect a charger to a battery for recharging.

### BRIEF DESCRIPTION OF THE DRAWINGS

Reference is made to the accompanying drawings in which are shown illustrative embodiments of the invention and from which novel features and advantages will be apparent.

FIG. 1 is a top perspective view of the battery cover connector system of the present invention installed on a battery.

FIG. 2 is an exploded view of the battery cover connector system of FIG. 1, a battery and the wiring harness of an electrical device.

FIG. 3 is a view of the inside region of a cap comprised by the invention shown in FIG. 1.

FIGS. 4-8 are alternative embodiments of the terminal connector comprised by the invention shown in FIG. 1.

### DETAILED DESCRIPTION

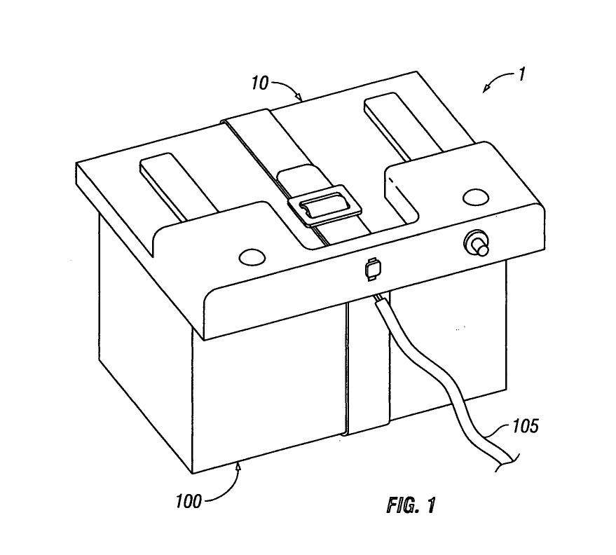

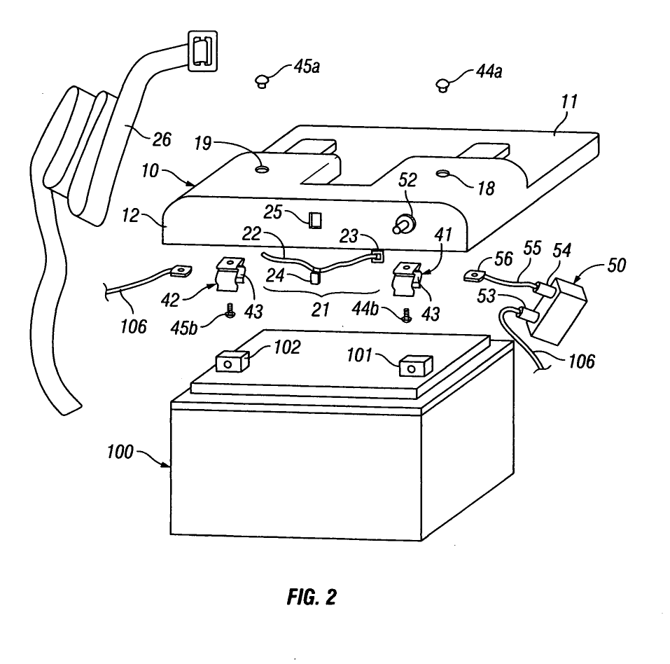

Referring to FIGS. 1 and 2 of the accompanying drawings, the battery cover connector system 1 of the present invention comprises means for covering a battery and means for connecting the battery to a wiring harness. The system 1 is adapted for use with a battery 100 having battery terminals which comprise negative 101 and positive 102 poles.

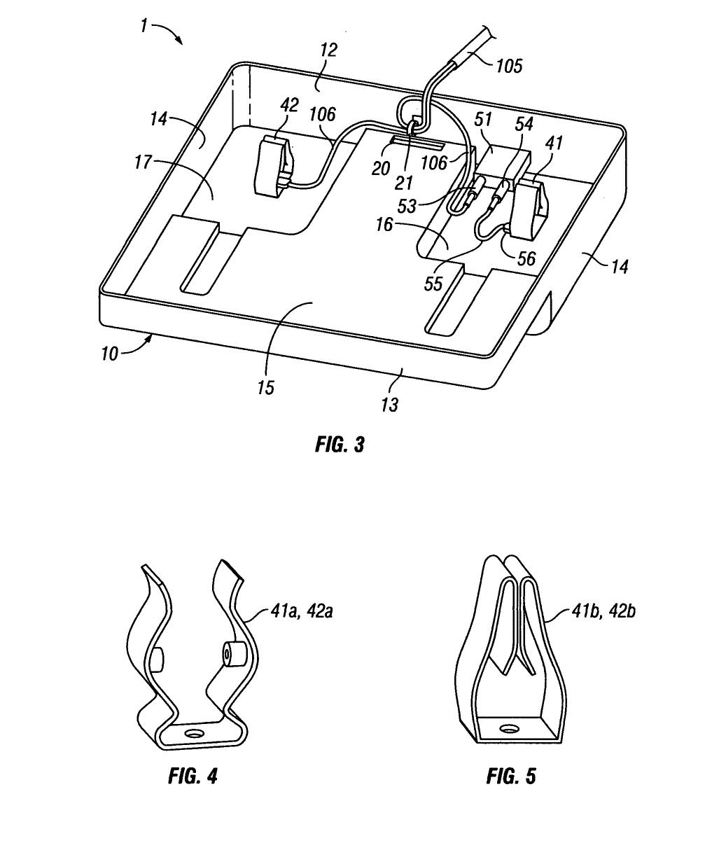

In FIGS. 2 and 3, the means for covering the battery is shown to comprise a cap 10 which includes a top 11, a front wall 12, a back wall 13 and a pair of lateral walls 14 which are arranged to form an interior region 15. A first 16 and second 17 concavity are formed in the top 11. Each of the first 16 and second 17 concavities includes an aperture therein, namely first 18 and second 19 apertures, respectively.

A slot 20 is disposed between the first 16 and second 17 concavity in the top 11 of the cap 10. Optionally, a strap 26 can be extended through the slot 20 and around the battery to further secure the battery cover connector system 1 thereto.

The connector system 1 further comprises a cable holder 21 which comprises a flexible tie 22, a releasable fastener 23 and an attaching portion 24. Disposed in the front wall 12 of the cap 10 is a holder support hole 25. The attaching portion 24 comprises an enlarged head that is snap fitted into the holder support hole 25 to removably attach the cable holder 21 to the front wall 12 of the cap 10.

The means for connecting the battery to the wiring harness comprises first 41 and second 42 terminal connectors. Preferably, each of the first 41 and second 42 terminal connectors is a spring clamp which includes a contact surface 43 for engaging respective negative 101 and positive 102 posts of the battery terminals. The first terminal connector 41 is secured to the cap 10 by a first attaching pin 44a, 44b and the second terminal connector 42 is secured to the cap 10 by a second attaching pin 45a, 45b.

The means for connecting the battery to the writing harness further comprises a circuit breaker 50. The circuit breaker 50 includes a main body 51 and a resetable actuator 52. The main body 51 has first 53 and second 54 breaker terminals, a connector wire 55 and a connector clamp 56.

The wiring harness 105 extending from the electrical device includes a plurality of wires 106. At least one such wire 106 of the wiring harness 105 is connected to the first breaker terminal 53. Connected to the second breaker terminal is the connector wire 55 and the connector clamp 56. The first attaching pin 44a, 44b secures the first terminal connector 41 to the top 11 of the cap 10 and secures the connector clamp 56 to the first terminal connector 41. The second attaching pin 45a, 45b secures at least one of the wires 106 of the wiring harness 105 to the second terminal connector 42 and also secures the second terminal connector 42 to the cap's top 11.

When attaching the system 1 to a battery 100, it is important that the terminal connectors 41, 42 be aligned with the proper battery terminal in order to avoid a reverse connection. Such a reverse connection between the battery's positive and negative posts and the terminal connectors 41,42 could damage the battery and/or the electrical device.

Although the preferred embodiment includes a circuit breaker 50, in an alternative embodiment the circuit breaker 50 may be eliminated altogether. In this alternative embodiment, the wiring harness 105 is attached to the cap 10 at the first terminal connector 41 instead of being attached to the circuit breaker.

The cap 10 is preferably made of a non-flammable, non-conductive material, such as a durable plastic. The contact surfaces 43 of the terminal connectors 41, 42 are preferably comprised of a bronze alloy. Alternatively, the terminal connectors 41, 42 could be made of other conductive materials that are capable of providing an electrical connection between the contact surface and the attached battery terminal.

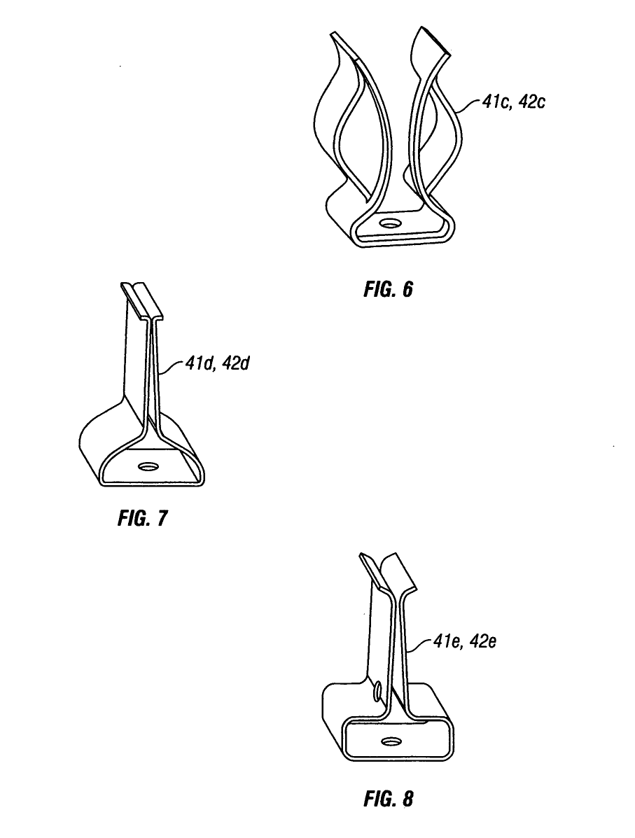

Additional embodiments of the battery cover connector system 1 can include alternative terminal connectors 41a-e, 42a-e which are shown in FIGS. 4-8. Each of the terminal connectors 41a-e, 42a-e of the alternative embodiments comprises contact surfaces made of materials similar to those of the preferred embodiment. As with terminal connectors 41, 42, the alternative terminal connectors 41a-e, 42a-e are adapted for contacting respective posts of the battery terminals.

The cap 10 also acts as a support frame to hold the terminal connectors 41, 42 at a predetermined distance from each other. This predetermined distance insures that each terminal connector 41, 42 will be properly positioned to engage a respective cooperating post 101, 102 when the cap 10 is fitted onto the battery 100. In addition, the cap 10 supports the wiring leads 106 of the wiring harness 105.

In the interior region 15, the first attaching pin 44a, 44b secures the first terminal connector 41 and the connector clamp 56 to the cap 10. The second attaching pin 45a, 45b secures the second terminal connector 42 and at least one of the wires 106 from the wiring harness 105 to the cap 10. The cable holder 21 secures the wiring harness 105 to the front wall 12 of the cap 10, so that the wiring harness 105 is maintained in an orderly manner within the interior region 15.

The terminal connectors 41, 42 each engage a respective terminal of the battery 100. When the battery cover connector system 1 is in use, each of the contact surfaces 43 establishes an electrical connection between its respective terminal connector 41, 42 and the attached battery post 101, 102.

The circuit breaker 50 senses overload conditions between the battery 100 and the wiring harness 105. In an overload situation, the circuit breaker 50 senses the overload and trips the resetable actuator 52 to interrupt the flow of electrical current. In a preferred embodiment, the resetable actuator 52 comprises a button. The button can be depressed to reset the circuit breaker 50 after it has been tripped. When the button is depressed, the circuit breaker 50 is reset and the electrical current is allowed to flow between the battery 100 and the wiring harness 105.

The cap 10 of the battery cover connector system 1 is sized to fit over the top of a battery such that the front 12, back 13 and lateral 14 walls surround at least a portion of the battery's sides, as shown in FIG. 1.

The first 16 and second 17 concavities are of a depth to space the respective first 41 and second 42 terminal connectors an appropriate distance from the battery's top surface to ensure that each of the contact surfaces 43 of the connectors 41, 42 is clamped to its respective battery post 101, 102 when the connector system 1 is positioned for use on a battery 100.

On the battery 100, each of the negative 101 and positive 102 posts is rectangularly shaped and extends upwardly from a top surface of the battery 100. The rectangular shape provides at least two generally flat areas for contacting a respective terminal connector 41, 42.

In a preferred embodiment, each of the first 41 and second 42 terminal connectors has at least two contact surfaces 43. When the connector system 1 is installed on a battery, the contact surfaces 43 of the respective terminal connector 41, 42 engage two opposing sides of the battery post 101, 102. The spring action of the terminal connector 41, 42 urges the contact surfaces 43 toward the post 101, 102, clamping the terminal connector 41, 42 to the respective post 101, 102. It can be appreciated that the contact surfaces 43 of the terminal connectors 41, 42 can vary in number and shape to coincide with a particular battery and the shape of its battery terminals.

Within the interior region 15, the first terminal connector 41 is positioned in the first concavity 16. The first attaching pin 44a, 44b is engaged with the first aperture 18, thereby securing the first terminal connector 41 to the top 11 of the cap 10.

The second terminal connector 42 is also disposed in the interior region 15 of the cap 10 and is secured by the second attaching pin 45a, 45b within the second concavity 17. The second attaching pin 45a, 45b is engaged with the second aperture 19 in the second concavity 17 and further secures the second terminal connector 42 to the cap's top 11.

It is desirable that the cap 10 fit somewhat snugly over the battery so that the terminal connectors 41, 42 properly engage the battery posts 101, 102 during installation and use. Consequently, the cable holder 21 is mounted on the front wall 12 of the cap 10. The cable holder 21 maintains the wiring harness 105 in close proximity to the front wall 12 and thereby inhibits the wiring harness 105 from interfering with the installation of the battery cover connector system 1 onto a battery 100. It is important that the contact surfaces 43 on each of the terminal connectors 41, 42 establish and maintain a good electrical connection with the battery posts 101, 102.

The main body 51 of the circuit breaker 50 is positioned within the interior region 15 and is mounted on the front wall 12 of the cap 10. The first breaker terminal 53 which extends from the circuit breaker's main body 51 is attached to the wiring harness 105. Adjacent to the first breaker terminal 53 is the second breaker terminal 54 which also extends from the main body 51. The connector wire 55 extends from the second breaker terminal 54 and is secured to the first terminal connector 41 via the connector clamp 56. The first terminal connector 41 is attached to the negative post 101 of a battery when the system 1 is installed.

As previously mentioned, it is important that the terminal connectors 41, 42 be attached to the proper battery terminal. This is done by initially positioning the system's cap 10 on the battery 100. Proper alignment between the cap 10 and battery 100 occurs when the first terminal connector 41 is directly aligned with the first battery post 101 and the second terminal connector 42 is directly aligned with the second battery post 102 as shown in FIG. 2.

The position of the terminal connectors 41, 42 on the cap 10 facilitates proper alignment of the connectors 41, 42 with the battery posts 101, 102 when installing the battery cover connector system 1 on a battery 100. The terminal connectors 41, 42 are positioned so that a first distance between the terminal connectors 41, 42 and the front wall 12 of the cap 10 is less than a second distance between the terminal connectors 41, 42 and the back wall 13. In other words, the terminal connectors 41, 42 are disposed on the cap 10 in a location that is closer to the front wall 12 of the cap than to the back wall 13.

The location of the terminal connectors 41, 42 on the cap 10 is a safety feature which deters a reverse connection being made between the terminal connectors 41, 42 and the battery posts 101, 102. It allows an electrical connection to occur between the wiring harness 105 and the battery 100 only when the cap 10 is properly positioned on the battery 100. The snug fit of the cap 10 onto the battery 100 further ensures that a proper electrical connection will occur.

In use, the battery cover connector system 1 is mounted on a battery 100 with the wiring harness 105 attached to the cap 10. Once the wiring harness 105 has been attached to the cap 10, it can remain attached thereby eliminating the need to detach or reattach the harness 105 to the cap each time the system 1 is connected or disconnected from a battery.

To connect a battery to an electrical device, the cap 10 is placed over the top side of the battery 100 with the interior region 15 encompassing a portion of the battery's top side. The terminal connectors 41, 42 are aligned with the posts 101, 102 of the battery terminals. With the terminal connectors 41, 42 and the battery terminals aligned, the cap 10 is pressed down so that the terminal connectors 41, 42 slip down over the respective posts 101, 102 and clamp onto the respective posts 101, 102. The contact surfaces 43 thereby engage the respective posts 101, 102 establishing electrical contact between the battery 100 and the wiring harness 105.

Conversely, to disconnect the battery 100 from an electrical device, the cap 10 is lifted away from the top of the battery 100, thereby separating the terminal connectors 41, 42 from the posts 101, 102 of the battery. By separating the terminal connectors 41, 42 from the battery posts 101, 102, the electrical connection between the contact surfaces 43 and the battery posts 101, 102 is severed and the battery 100 is released from its connection to the wiring harness 105.

Optionally, a strap 56 can be included with the system 1 to assist in securing the cap 10 to the battery 100. By positioning the strap 26 under the battery, one end of the strap is then threaded through the slot 20 in the cap 10. Subsequently, the strap 26 is tightened around the cap 10 and battery 100 and then secured in place. To remove the cap 10 from the battery 100, the strap 26 is released and disengaged from the cap 10.

The battery cover connection system of the present invention provides a quick and easy connection between a battery and an electrical device. In addition, the system provides a safe and effective means for properly connecting the battery to the electrical device.

The battery cover connection system of the present invention can also be used to connect a battery to other types of electrical devices or accessories including a battery charger.

It can be appreciated that the battery cover connection system of the present invention can be used to connect a battery to an electric-powered vehicle—and also to connect a battery in a non-electric vehicle for the purpose of starting the vehicle or powering the vehicle's accessories.

A preferred embodiment of the present invention comprises the wiring configuration of the wiring harness shown in FIGS. 1-3. However, other preferred embodiments of the invention may comprise alternative wiring configurations and therefore include a different wiring harness from that shown herein. The wiring harness may vary depending upon the device or devices to which the battery cover connector system is connected. For instance, additional wiring may be added to the harness if it is desired to connect the battery cover connector system to multiple components, such as controller elements, lights, power ports, fans and the like. Therefore, the spirit and scope of the appended claims should not be limited to the description of the preferred versions contained herein.

1. A battery cover connector system for connecting a battery having positive and negative terminal posts to a wiring harness on a device, the battery cover connector system comprises:
means for covering the battery, and
means for connecting the battery to a wiring harness.

2. The battery cover connector system of claim 1, wherein said means for connecting the battery to a wiring harness comprises first and second terminal connectors for connecting to the battery terminals.

3. The battery cover connector system of claim 2, wherein said first terminal connector comprises a spring clamp that removably snap fits onto the negative terminal post of the battery and said second terminal connector comprises a spring clamp that removably snap fits onto the positive terminal post of the battery.

4. The battery cover connector system of claim 3, wherein each of said spring clamps comprises at least one contact surface that directly engages the respective positive and negative terminal posts of the battery to form an electrical connection between the battery and the wiring harness.

5. The battery cover connector system of claim 4, wherein said means for covering the battery is a cap which covers a top portion of the battery.

6. The battery cover connector system of claim 5, wherein said cap comprises a top, a front wall, a back wall, a pair of lateral walls, and an interior region;
wherein said interior region is formed by the top, front wall, back wall and lateral walls.

7. The battery cover connector system of claim 6, wherein said first and second terminal connectors are located a first distance from the front wall of the cap and a second distance from the back wall of the cap, wherein said first distance is less than said second distance.

8. The battery cover connector system of claim 7, wherein said front and back walls are proximate and adjacent to sides of the battery.

9. The battery cover connector system of claim 1, wherein said means for covering the battery is a cap which covers a top portion of the battery.

10. The battery cover connector system of claim 9, wherein said cap comprises a top, a front wall, a back wall and lateral walls defining an interior region adapted to receive a portion of the battery therein.

11. The battery cover connector system of claim 10, wherein said front and back walls are adjacent to sides of said battery and said top is adjacent the top of said battery during use.

12. The battery cover connector system of claim 11 further comprises a cable holder for securing the wiring harness to the cap, wherein said cable holder is mounted on the front wall of the cap.

13. The battery cover connector system of claim 10, wherein said first and second terminal connectors are located a first distance from the front wall of the cap and a second distance from the back wall of the cap, wherein said first distance is less than said second distance.

14. A battery cover connector system for connecting a battery having positive and negative terminal posts to a wiring harness on a device, the battery cover connector system comprises:
a cap; and
first and second terminal connectors disposed on said cap;
said cap comprising a top, a front wall, a back wall, lateral walls and an interior region, wherein said interior region of said cap is formed by the top, front wall, back wall and lateral walls;
said first terminal connector engages the negative terminal post on the battery, and said second terminal connector engages the positive terminal post on the battery.

15. The battery cover connector system of claim 14, wherein said first and second terminal connectors are located a first distance from the front wall of the cap and are further located a second distance from the back wall of the cap, wherein said first distance is less than said second distance.

16. The battery cover connector system of claim 15, wherein said first terminal connector comprises a spring clamp for releasably engaging said negative terminal post of the battery, and said second terminal connector comprises a spring clamp for releasably engaging said positive terminal post of the battery.

17. The battery cover connector system of claim 16, wherein the top of said cap includes first and second concavities disposed thereon; and
said first terminal connector is disposed in said first concavity and said second terminal connector is disposed in said second concavity.

18. The battery cover connector system of claim 16, further comprising a circuit breaker;
said circuit breaker comprises a main body and a resetable actuator;
said main body includes first and second breaker terminals and a connector wire with a connector clamp disposed on one end;
wherein said first breaker terminal is connected to the wiring harness, said second breaker terminal is connected to an opposite end of the connector wire, and said connector clamp is attached to the first terminal connector.

19. The battery cover connector system of claim 15, further comprises a cable holder mounted on the front wall of said cap;
said cable holder comprising a flexible tie adapted to engage a portion of the wiring harness.

20. The battery cover connector system of claim 15, wherein said front and back walls of the cap are proximate and adjacent to sides of the battery.

21. The battery cover connector system of claim 20, wherein said cap further comprises a slot disposed in the top thereof, and a strap disposed in said slot to secure the cap to the battery.

22. A battery cover connector system for connecting a battery having positive and negative terminal posts to a wiring harness on an electrical device, the battery cover connector system comprises:
a cap which covers a top portion of the battery;
first and second terminal connectors;
a circuit breaker; and
a cable holder for securing the wiring harness to the cap;
said cap includes a top, a front wall, a back wall, a pair of lateral walls, and an interior region, wherein said front and back walls are positioned proximate and adjacent to sides of an attached battery;
said top having first and second concavities and a slot formed therein;
said first concavity has a first aperture and said second concavity has a second aperture;
wherein said interior region of said cap is defined by the top, front wall, back wall and lateral walls;
said front wall includes a holder support hole;
a strap is disposed in said slot to secure the cap to the battery;
said cable holder comprises a flexible tie having a releasable fastener and an attaching portion with an enlarged head, wherein said enlarged head of said cable holder is removably engaged with said holder support hole on the front wall of said cap and said flexible tie releasably secures the wiring harness;
said first terminal connector comprises a spring clamp having at least one contact surface for engaging the negative terminal post of the battery;
said second terminal connector comprises a spring clamp having at least one contact surface for engaging the positive terminal post of the battery, wherein said first terminal connector is mounted in said first concavity of said cap and said second terminal connector is mounted in said second concavity of said cap;
said first and second terminal connectors are located a first distance from the front wall of the cap and are further located a second distance from the back wall of the cap, wherein said first distance is less than said second distance;
said circuit breaker includes a main body, and a resetable actuator;
said main body has first and second breaker terminals, a connector wire with a connector clamp, wherein said first breaker terminal is adapted to be connected to the wiring harness, said second breaker terminal is connected to the connector wire, the connector clamp is attached to the first terminal connector and the wiring harness is attached to the second terminal connector;
wherein to install the battery cover connector system on a battery, the cap is positioned adjacent to the top of the battery with the first terminal connector aligned with the negative terminal post of the battery, the second terminal connector aligned with the positive terminal post of the battery, the cap is pressed toward the battery, thereby forcing the spring clamps of the terminal connectors to snap fit onto the respective aligned positive and negative posts such that the contact surfaces of each spring clamp makes electrical contact with the respective battery terminal and the walls of the cap are around the battery, and the strap is engaged; and
wherein to remove the battery cover connector system from an attached battery, the strap is released and the cap is lifted away from the battery, thereby separating the first and second terminal connectors from the battery terminals.
